(19) United States
(12) Patent Application Publication
(10) Pub. No.: US 2009/0290699 A1
(43) Pub. Date: Nov. 26, 2009

(54) Pseudo caller ID message formation and transmission method and apparatus

(76) Inventor: Shary Nassimi, Malibu, CA (US)

Correspondence Address: FITCH EVEN TABIN & FLANNERY, 120 SOUTH LASALLE STREET, SUITE 1600, CHICAGO, IL, 60603-3406, US

(21) Appl. No.: 12/154,081

(22) Filed: May 20, 2008

(51) Int. Cl. H04M 15/06

(52) U.S. Cl. 379/142.17

(57) ABSTRACT

A telephone seizure apparatus (300) is configured and arranged to incorporate (103) a non-telephonic network caller ID message into a telephonic network caller ID message to thereby provide a resultant pseudo caller ID message. The telephone seizure apparatus can then transmit (104) this pseudo caller ID message to a caller ID interpreter such that the caller ID interpreter can send the non-telephonic network caller ID message to a corresponding caller ID display.

### TECHNICAL FIELD

This invention relates generally to data communications and more particularly to caller ID protocol and messages.

### BACKGROUND

Communications systems and approaches of various kinds are known in the art. Many such systems will support the conveyance of messages including, without limitation, messages comprised of alphanumeric characters. In some cases particularly well known protocols or specification standards are available for use in such an application setting. As one example in this regard, the well known American Standard Code Information Interchange (ASCII) standard provides a well accepted standard by which alphanumeric characters can be represented using binary data values.

Unfortunately, for the most part, a wide variety of differing signaling protocols and formats tend to characterize these various communications systems. As a result, many communication systems are non-compatible with one another; that is, a message-bearing signal cannot be readily conveyed between and understood by two differing communication systems in many cases. This, in turn, contributes to the increasing proliferation of differing communication methodologies and platforms that are potentially available for use in a given application setting.

That a number of differing communication system options are available to meet different communication needs is not always a satisfactory condition. Such a paradigm tends to lead to an increased number of communication platforms in order to support all of the communication needs of a given end user. This, in turn, can lead to increased costs, increased training requirements, increased space requirements, increased maintenance and support requirements, and so forth.

### BRIEF DESCRIPTION OF THE DRAWINGS

The above needs are at least partially met through provision of the pseudo caller id message formation and transmission method and apparatus described in the following detailed description, particularly when studied in conjunction with the drawings, wherein:

FIG. 1 comprises a flow diagram as configured in accordance with various embodiments of the invention;

FIG. 2 comprises a signaling protocol schematic view as configured in accordance with various embodiments of the invention;

FIG. 3 comprises a block diagram as configured in accordance with various embodiments of the invention; and

FIG. 4 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a telephone seizure apparatus is configured and arranged to incorporate a non-telephonic network caller ID message into a telephonic network caller ID message to thereby provide a resultant pseudo caller ID message. The telephone seizure apparatus can then transmit this pseudo caller ID message to a caller ID interpreter such that the caller ID interpreter can send the non-telephonic network caller ID message to a corresponding caller ID display.

By one approach, the telephone seizure apparatus can locally develop the aforementioned non-telephonic network caller ID message. In such a case, for example, this message can comprise information regarding a learning state or a call forwarding state of the telephone seizure apparatus. By another approach, the telephone seizure apparatus can receive a message from a remote source (such as, but not limited to, a wireless intercom apparatus) and then use that message, at least in part, to determine the aforementioned non-telephonic network caller ID message. In such a case, for example, this remotely sourced message can comprise, at least in part, information that identifies a particular facility point-of-access and/or a status of the remote source itself.

So configured, an end user's existing caller ID interpreter (such as a caller ID-capable telephone or a so-called caller ID box) can serve further duty by causing a display of other kinds of information. This can occur without modifying in any way the essential operations of the caller ID interpreter as the latter can process the pseudo caller ID message as an actual caller ID message. This, in turn, permits the caller ID interpreter's native capabilities to be further leveraged in service of non-caller ID functionality. As a result, in many cases, this can lead to a reduced need for uniquely dedicated communications system devices for a given end user (thus saving money, reducing installation and maintenance requirements, and minimizing training requirements).

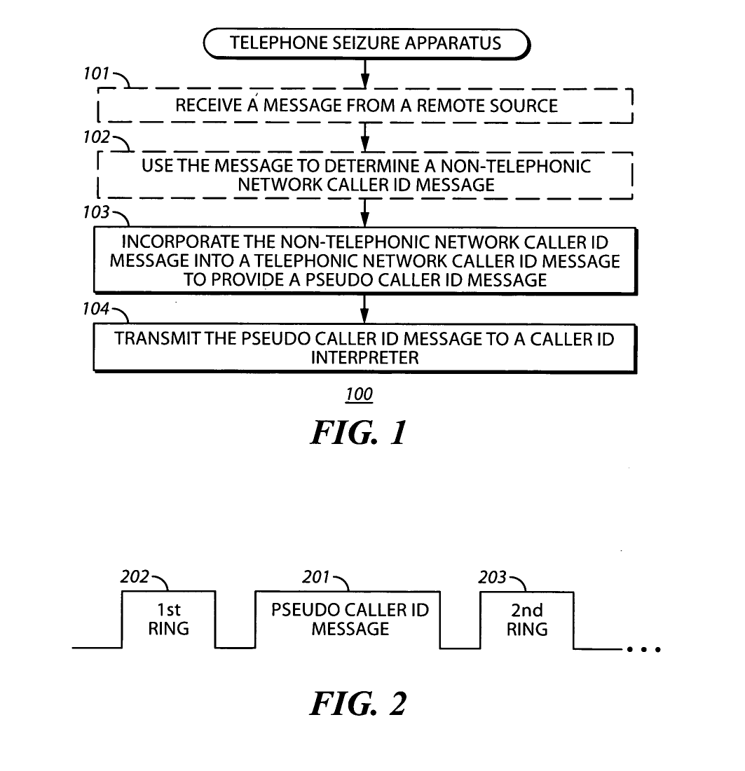

These and other benefits may become clearer upon making a thorough review and study of the following detailed description. Referring now to the drawings, and in particular to FIG. 1, an illustrative process that is compatible with many of these teachings will now be presented. This process 100 can be carried out by a variety of enabling platforms. For the sake of example and for the purposes of illustration, this description will present the process 100 as being carried out by a telephone seizure apparatus of choice. Such platforms are known in the art and require no further elaboration here except where further relevant details are presented below.

As noted above, these teachings pertain to the incorporation of a non-telephonic network caller ID message into a telephonic network caller ID message in order to provide a resultant pseudo caller ID message. As used herein, this expression “non-telephonic network caller ID message” will be understood to refer to a message that is to be conveyed as a caller ID message but that is not substantively itself a traditional telephone network caller ID message (where a traditional telephone network caller ID message will be understood to comprise a telephone number as corresponds to a telephone that is sourcing a present attempt to initiate a telephone call along with the optional inclusion of an alphanumeric representation of a party's name that is associated with that particular telephone). The non-telephonic network caller ID message itself can comprise bearer content (that is, substantive content) from any of a variety of sources. By one approach, for example, this process 100 will optionally provide for receiving 101 a message from a remote source and then using 102 that received message, at least in part, to determine the non-telephonic network called ID message.

This remote source can of course vary from one application setting to another. By one approach, and for the sake of example, this remote source can comprise an intercom apparatus (including either a wireline or a wireless intercom apparatus). This intercom apparatus might comprise, for example, a part of an access control system. In such a case, and still by way of example, a point-of-access for a given facility (such as a front entry door for an apartment complex) can be ordinarily locked and a user interface provided to permit a visitor to contact a particular apartment dweller via the intercom apparatus. Upon speaking with the visitor and verifying their identity and/or intent, the apartment dweller then remotely disables the locking mechanism for the point-of-access to permit the visitor to enter the facility.

In such a case, the message from the remote source can comprise any of a variety of useful messages. For example, the received message can serve to identify, at least in part, the particular facility point-of-access as corresponds to the remote source. This can be useful when a given facility has a plurality of different points-of-access, such as, for example, a street-level entry door and a garage-level entry door. As another example, the received message can identify, at least in part, a status of the remote source. Examples of such status might include, but are not limited to, battery status of the remote source (indicating, for example, general or specific information about present energy reserves and capacity), tamper detection (indicating, for example, a recently or presently detected attempt to tamper in some physical or electrical way with the remote source), a detected request for access at a front point-of-access, a back point-of-access, or the like, and so forth.

By one approach, the step of using 102 the message to determine a non-telephonic network caller ID message can essentially comprise using the received message in its received form. This can comprise using the received message in both its verbatim substantive form and in its encoded form as well. By another approach, this step can comprise using the verbatim substantive form of the received message but converting (for example, by transcoding) that received message into a different format. By yet another approach, this step can comprise translating the verbatim substantive form into an alternative non-verbatim form while retaining the substance of the message. As a simple example in this regard, a given remote source may provide a message that simply comprises the characters “0001.” The telephone seizure apparatus may utilize this message to access a lookup table to thereby associate this message with a corresponding non-telephonic network caller ID message such as the words “FRONT DOOR VISITOR.” Other possibilities in these regards will no doubt occur to those skilled in the art.

These teachings will accommodate other sources for the non-telephonic network caller ID message. For example, by one approach, the platform effecting this process 100 (i.e., in this case, the telephone seizure apparatus) can self-source this non-telephonic network caller ID message. In such a case, the message can comprise, at least in part and by way of example, a message regarding an operational state of the telephone seizure apparatus. Examples of possibly useful operational states comprise, but are not limited to, a learning state of a call forwarding state. The former can be useful, for example, when the enabling platform has a learning mode of operation (to learn, for example, legitimate and authorized remote sources and their particular corresponding identifiers).

In any event, and regardless of where and how the non-telephonic network caller ID message is received and/or otherwise sourced or provided, this process 100 then provides for incorporating 103 that message into a telephonic network caller ID message to thereby provide a pseudo caller ID message. In a typical though not mandatory application setting, the pseudo caller ID message can comprise, at least in part, alphanumeric characters to express the non-telephonic network caller ID message content. This can comprise, for example, representing the latter content using ASCII character data in accordance with well understood practice in this regard. This typically comprises, for example, representing each alphanumeric character with an eight bit code that is itself preceded by a 0 start bit and followed by a 1 stop bit.

The form and protocol of telephonic network caller ID messages are well known in the art. For the sake of brevity and for the purpose of clarity, further elaboration in this regard will not be provided here.

This process then provides for transmitting 104 the pseudo caller ID message to a caller ID interpreter. This, in turn, permits the caller ID interpreter to extract the message content and to send the non-telephonic network caller ID message to a corresponding caller ID display. This transmission can comprise a transmission via local wiring if desired (where “local wiring” will be understood to refer to a physically bounded carrier (such as an electrical conductor or an optical carrier) that is disposed within the corresponding facility).

In accordance with well understood practice, this transmission can comprise the use of frequency shift keying as the means of conveying the binary information that comprises the pseudo caller ID message. Using this approach, for example, a first tone or frequency (such as 1,200 Hz) can serve to represent binary 1's while a second tone or frequency (such as 2,200 Hz) can serve to represent binary 0's. It will also be understood that this transmission of the pseudo caller ID message can include such other protocol mechanisms as are ordinary and usual for caller ID messaging. This can comprise, for example, providing an alternating series of 1's and 0's and a follow-on dotting pattern to facilitate synchronization, providing a byte to represent the message type, providing another byte to represent the length of the message, providing a time stamp, and providing a checksum byte as is usual and typical with modern caller ID messaging protocols.

Referring now to FIG. 2, caller ID messages are typically transmitted between a first ring signal 202 and a next subsequent ring signal (i.e., a second ring signal 203). In keeping with this approach, the aforementioned transmission of the pseudo caller ID message 201 can also be provided in-between the first ring 202 and the second ring 203.

So configured, a useful quantity of alphanumeric content can be reliably and inexpensively conveyed using standard caller ID message formatting and transmission techniques. By this approach, the substantive content is readily and compatibly receivable by a caller ID interpreter notwithstanding that the message content itself is not, in and of itself, caller ID content as corresponds to the telephone network (i.e., the message does not constitute the telephone number of a calling telephone along with, or in the absence of, an identifier as corresponds to that calling telephone).

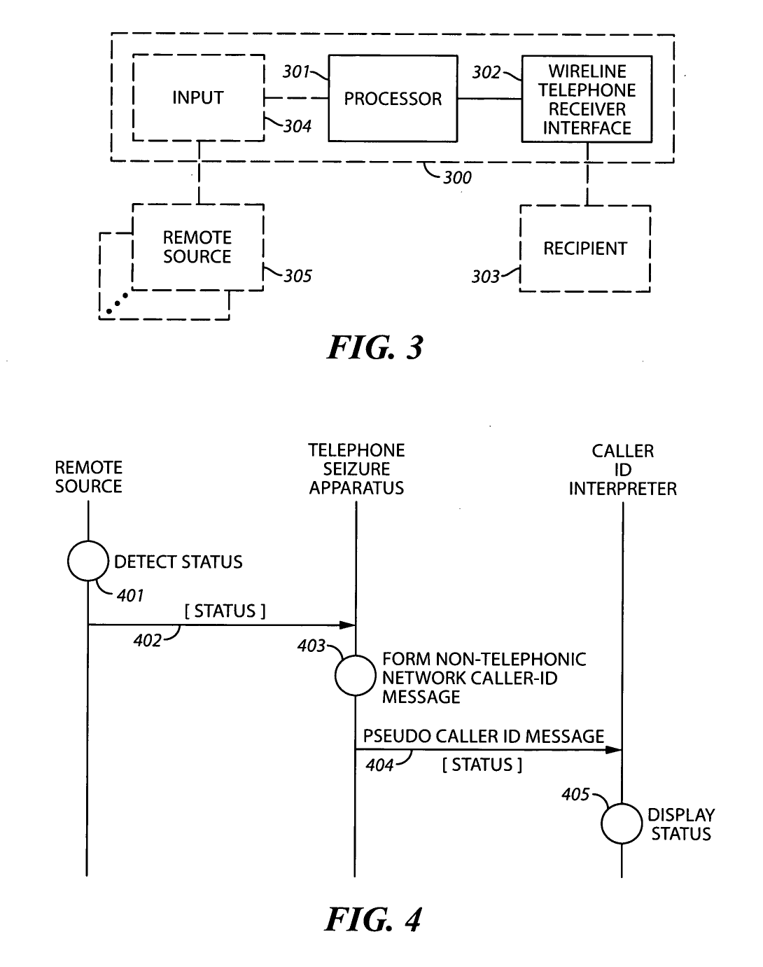

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided. In this illustrative example, the apparatus 300 comprises a telephone seizure apparatus, though those skilled in the art will recognize and understand that other possibilities for a suitable enabling platform exist as well and others are likely to be developed going forward.

In this example, the apparatus 300 comprises a processor 301 that operably couples to a wireline telephone receiver interface 302. Those skilled in the art will recognize and appreciate that such a processor 301 can comprise a fixed-purpose hard-wired platform or can comprise a partially or wholly programmable platform. All of these architectural options are well known and understood in the art and require no further description here. The wireline telephone receiver interface 302, in turn, can serve to operably couple the processor 301 to a recipient apparatus 303 (such as a dedicated caller ID interpreter, a caller ID-capable telephone, and so forth) via, for example, local wiring as suggested above.

If desired, the apparatus 300 can further comprise an input 304 that also operably couples to the processor 301 and which facilitates receiving, for example, a message from a remote source 305 of choice. By one approach this input 304 can comprise a wireless input to thereby facilitate receiving such a message via a wireless carrier and technology of choice. Such a choice will serve well when the remote source 305 comprises, for example, a wireless intercom apparatus as discussed above. It would also be possible, of course, for this input 304 to comprise a wireline input to facilitate interfacing with, for example, a corresponding electrical conductor, an optical conductor, or the like.

Such a processor 301 can be configured and arranged (via, for example, corresponding programming as will be well understood by the skilled artisan) to carry out or otherwise effect one or more of the steps, actions, and functionally as has been set forth herein. This can comprise, for example, configuring and arranging the processor 301 to incorporate a non-telephonic network caller ID message (as may have self-sourced or as may have been received, for example, from a remote source 305) into a telephonic network caller ID message to thereby provide the aforementioned pseudo caller ID message. This could also comprise configuring and arranging the processor 301 to transmit this pseudo caller ID message to a receiving device such as the illustrated recipient 303 via the wireline telephone receiver interface 302. By this approach, the recipient 303 can thereby be caused to present the non-telephonic network caller ID message via a corresponding caller ID display to a user of the receiving device.

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

An illustrative, albeit non-limiting, example will now be provided with reference to FIG. 4. In this example, a remote source (such as a wireless intercom that comprises a part of an access control system for a given corresponding facility) detects a particular status 401. This might comprise, for the sake of example, sensing that a visitor has asserted a push button user interface on the wireless intercom. The remote source then forwards a message 402 which represents that status in an appropriate and desired format to a telephone seizure apparatus.

In response to receiving this message 402, the telephone seizure apparatus forms a corresponding non-telephonic network caller-ID message 403. As noted above, this message 403 might comprise a substantively verbatim expression of the original status information or might comprise instead a recasting of that content into a new form as desired, The telephone seizure apparatus then transmits a pseudo caller ID message 404 that contains the substantive status information as was originally sourced by the remote source.

A caller ID interpreter receives this pseudo caller ID message 404 and processes the pseudo caller ID message 404 as an ordinary caller ID message. This will lead to the caller ID interpreter extracting the status information being carried by the pseudo caller ID message 404 and displaying that information 405 using a corresponding caller ID display.

Those skilled in the art will recognize and appreciate that these teachings represent a simple and highly cost effective mechanism for permitting ordinary caller ID interpreters (such as dedicated modules, telephones, properly programmed personal computers, and so forth) to also serve as display platforms for displaying content that does not, in fact, comprise ordinary caller ID content. These benefits are achieved without requiring any reprogramming or alteration of the caller ID interpreter and without compromising in any way the ordinary functionality and use of the caller ID interpreter. It will also be recognized that these teachings are highly scalable. This being so, these teachings can be readily applied in an application setting having a relatively large number of remote sources that source messages to be displayed via the caller ID interpreter.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a telephone seizure apparatus:
incorporating a non-telephonic network caller ID message into a telephonic network caller ID message to provide a pseudo caller ID message;
transmitting the pseudo caller ID message to a caller ID interpreter such that the caller ID interpreter can send the non-telephonic network caller ID message to a caller ID display.

2. The method of claim 1 wherein the non-telephonic network caller ID message comprises, at least in part, a message regarding an operational state of the telephone seizure apparatus.

3. The method of claim 2 wherein the operational state pertains to at least one of:
a learning state;
a call forwarding state.

4. The method of claim 1 wherein the pseudo caller ID message comprises alphanumeric characters.

5. The method of claim 1 wherein transmitting the pseudo caller ID message comprises transmitting the pseudo caller ID message via local wiring to a local telephone receiver.

6. The method of claim 1 wherein transmitting the pseudo caller ID message comprises transmitting the pseudo caller ID message in between transmissions of a first and a next, subsequent ring signal to the telephone receiver.

7. The method of claim 1 further comprising:
receiving a message from a remote source;
using the message, at least in part, to determine the non-telephonic network caller ID message to be incorporated into the telephonic network caller ID message when providing the pseudo caller ID message.

8. The method of claim 7 wherein the remote source comprises a wireless intercom apparatus.

9. The method of claim 8 wherein the non-telephonic network caller ID message identifies, at least in part, a particular facility point-of-access.

10. The method of claim 8 wherein the non-telephonic network caller ID message identifies, at least in part, a status of the wireless intercom apparatus.

11. The method of claim 10 wherein the status of the wireless intercom apparatus represents at least one of:
battery status;
tamper detection;
a detected request for access at a front point-of-access;
a detected request for access at a back point-of-access.

12. An apparatus comprising:
a wireline telephone receiver interface;
a processor that is operably coupled to the wireline telephone receiver interface and that is configured and arranged to:
incorporate a non-telephonic network caller ID message into a telephonic network caller ID message to provide a pseudo caller ID message;
transmit, via the wireline telephone receiver interface, the pseudo caller ID message to a receiving device having a caller ID display to thereby cause the caller ID display to present the non-telephonic network caller ID message to a user of the receiving device.

13. The apparatus of claim 12 wherein the apparatus comprises a telephone seizure device.

14. The apparatus of claim 12 wherein the non-telephonic network caller ID message comprises, at least in part, a message regarding an operational state of the apparatus.

15. The apparatus of claim 14 wherein the operational state pertains to at least one of:
a learning state;
a call forwarding state.

16. The apparatus of claim 12 wherein the pseudo caller ID message comprises alphanumeric characters.

17. The apparatus of claim 12 wherein the processor is configured and arranged to transmit the pseudo caller ID message by transmitting the pseudo caller ID message in between transmissions of a first and a next subsequent ring signal to the receiving device.

18. The apparatus of claim 12 further comprising:
an input that is operably coupled to the processor; and wherein the processor is further configured and arranged to:
receive a message from a remote source via the input;
use the message, at least in part, to determine the non-telephonic network caller ID message to be incorporated into the telephonic network caller ID message when providing the pseudo caller ID message.

19. The apparatus of claim 18 wherein the input comprises a wireless input.

20. The apparatus of claim 19 wherein the remote source comprises a wireless intercom apparatus.

21. The apparatus of claim 20 wherein the non-telephonic network caller ID message identifies, at least in part, a particular facility point-of-access.

22. The apparatus of claim 20 wherein the non-telephonic network caller ID message identifies, at least in part, a status of the wireless intercom apparatus.

23. The apparatus of claim 22 wherein the status of the wireless intercom apparatus represents at least one of:
battery status;
tamper detection;
a detected request for access at a front point-of-access;
a detected request for access at a back point-of-access.
